(19) United States
(12) Patent Application Publication
(10) Pub. No.: US 2009/0265663 A1
(43) Pub. Date: Oct. 22, 2009

(54) SYSTEMS AND METHODS FOR COMMUNICATION BETWEEN USER INTERFACES

(75) Inventor: WEN-CHIEH KUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/272,792

(22) Filed: Nov. 18, 2008

(30) Foreign Application Priority Data
Apr. 18, 2008 (CN) 200810301189.2

(51) Int. Cl. G06F 3/00

(52) U.S. Cl. 715/804

(57) ABSTRACT

A computing system for communication between user interfaces of test programs is provided. The system includes a first user interface, a communication interface, a second user interface, and a processor. The communication interface receives a test command issued from the first user interface. The second user interface polls the communication interface and stops polling upon detection of successful reception of the test command by the communication interface. The second user interface retrieves the test command from the communication interface and executes the test command. The processor executes the first user interface, the communication interface and the second user interface. A computer-implemented method for communication between user interfaces of test programs is also provided.

### BACKGROUND

1. Field of the Invention

Embodiments of the present disclosure relate to testing computer software, and more particularly to a system and a method for communication between user interfaces.

2. Description of Related Art

Thoroughly testing computer programs are a very expensive undertaking for development enterprises. One such testing program uses a testing framework incorporating other developed testing tasks with a main test. Generally, the main test provides a user interface (UI) recording some or all user input, such as keystrokes, mouse events, and others.

Even so, deployment of widely varying UI-based application types, while the basic concepts of each are similar, results in differences in actual implementation. In particular, a mandatory property for one application is often optional for another. Further, in the interest of added value, some of the properties that are to be mandatory may have been missed. As a result, in most programs, no single set of properties can be used to uniquely identify all controls.

Accordingly, what is needed is a system and a method for communication between different user interfaces addressing the limitations discussed.

### SUMMARY

A computing system for communication between user interfaces of test programs is provided. The system includes a first user interface, a communication interface, a second user interface, and a processor. The first user interface issues a test command. The communication interface receives the test command from the first user interface. The second user interface polls the communication interface and stops polling upon detection of successful reception of the test command by the communication interface. The second user interface retrieves the test command from the communication interface and executes the test command. The processor executes the first user interface, the communication interface and the second user interface.

Other advantages and novel features of the a system and a method for communication between different user interfaces will become more apparent from the following detailed description of certain inventive embodiments when taken in conjunction with the accompanying drawings.

### BRIEF DESCRIPTION OF THE DRAWINGS

FIG. 1 is a schematic diagram of an embodiment of a system for communication between different user interfaces; and

FIG. 2 is a flowchart of an embodiment of a method for communication between different user interfaces.

### DETAILED DESCRIPTION OF CERTAIN INVENTIVE EMBODIMENTS

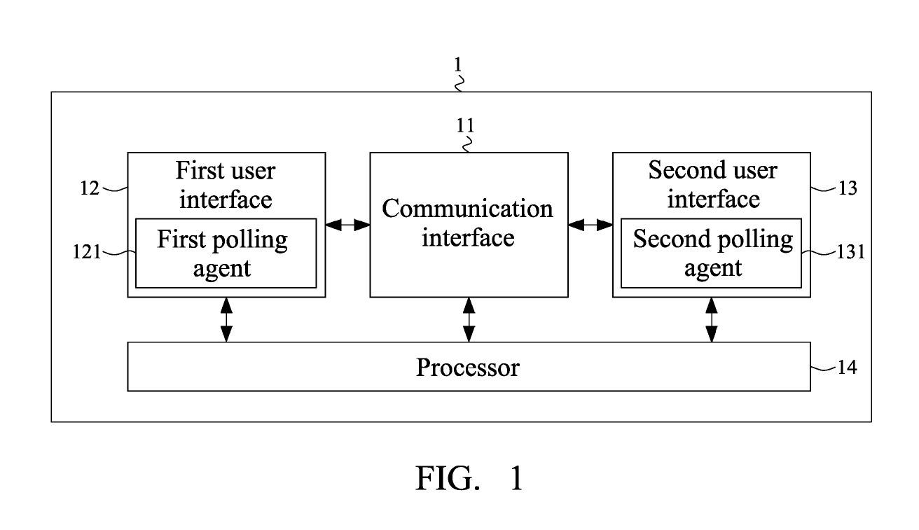

FIG. 1 is a schematic diagram of one embodiment of a system 1 for communication between different user interfaces of test programs. In one embodiment, an electronic apparatus, such as a desktop computer, includes two test programs and the system 1 for communication between the user interfaces of the two test programs. In other embodiments, the electronic apparatus may be, a notebook computer, a server, or other device, without departing from the spirit of the disclosure.

In one embodiment, the system 1 includes a communication interface 11, a first user interface 12, a second user interface 13, and at least one processor 14 for executing the first user interface 12, the communication interface 13 and the second user interface 14. The first user interface 12 and the second user interface 13 are user interfaces of the installed test programs. The test programs include a plurality of testing commands for tested components, such as a camera module or an audio module, connected to the system 1. All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

The communication interface 11 is a common interface for providing indirect communication between the first user interface 12 and the second user interface 13. In other embodiments, the communication interface 11 can provide indirect communications between a plurality of user interfaces, such as providing indirect communications for three user interfaces of the installed test programs.

The communication interface 11 maintains a configuration file for recording corresponding transactions between the first user interface 12 and the second user interface 13. For example, the configuration file can include the variables “Test Start,” “Test Finish,” “A Function Test Result,” “B Function Test Result,” “C Function Test Result”, and others The variables have default values equaling zero. In other embodiments, other variables may be included in the configuration file in response to the testing commands.

The variable “Test Start” determines whether a test for different components is initiated, and the components to be tested will be listed below the variable “Test Start.” The variable “Test Finish” determines whether the test is terminated.

The variables “A Function Test Result”, “B Function Test Result” and “C Function Test Result” respectively represent results of the test commands for different tested components “A,” “B” and “C.” If the tested component passes the function test, the corresponding variable is set to one.

Before initiating the test, the first user interface 12 first sends a command resetting the configuration file of the communication interface 11. The test instructing the second user interface 13 to perform “A Function Test Result,” “B Function Test Result,” and “C Function Test Result,” is used here as an example to describe the transactions between the first user interface 12, communication interface 11, and the second user interface 13.

After resetting the configuration file, the first user interface 12 sends a test command to the communication interface 11. The first user interface 12 includes a first polling agent 121 polling the communication interface 11, such as periodically sending polling signals to the communication interface 11, after the test command is issued.

The second user interface 13 includes a second polling agent 131. The second polling agent 131 begins polling the communication interface 11 after the test is initiated. Upon detection of successful reception of the test command by the communication interface 11, the second polling agent 131 stops polling.

The second user interface 13 retrieves the test command from the communication interface 11 by reading the configuration file to identify that the test command is to be applied to tested component “A,” “B” and “C.” Before executing the test command, the second user interface 13 sends a command setting the value of the variable “Test Start” of the configuration file to one.

The second user interface 13 then applies the test command to the tested components indicated in the configuration file. Upon completing the test, the second user interface 13 further issues a command setting the value of the variable “A Function Test Result,” “B Function Test Result” and “C Function Test Result” in accordance with the test result for the respective tested components. For example, if the testing result shows that the test for the “A” component is successful, the second user interface 13 issues a command setting the value of the variable “A Function Test Result” to one. Otherwise, the value of the variable “A Function Test Result” is set to zero.

In addition, the second user interface 13 also issues a command setting the value of the variable “Test Finish” to one to indicate that the test is accomplished. Thus, the testing result is transmitted from the second user interface 13 to the communication interface 11.

As described, the first polling agent 121 begins polling the communication interface 11 after the test command is issued. Upon detection of successful reception of the test result by the communication interface 11, the first polling agent 121 stops polling. The first user interface 12 further retrieves the test results from the communication interface 11 and records the test results accordingly.

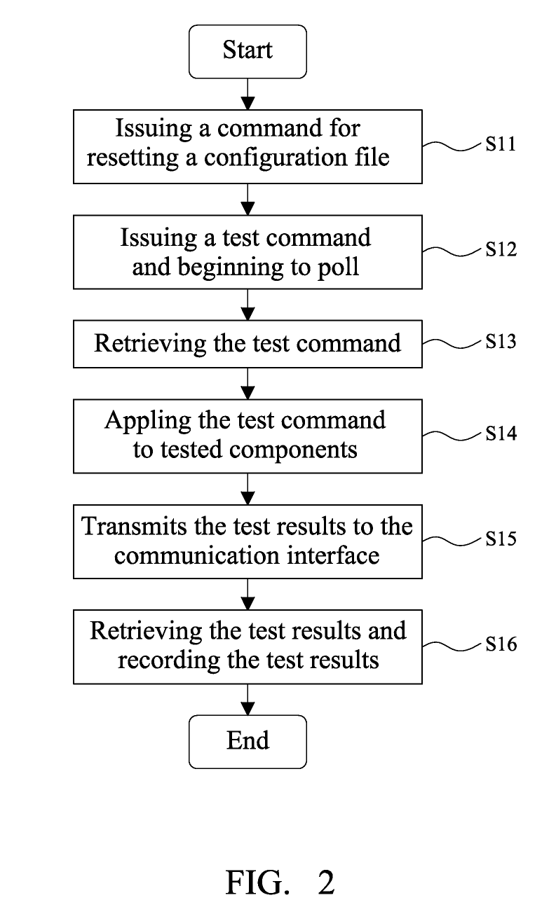

FIG. 2 is a flowchart of an embodiment of a method for communication between user interfaces. Depending on the embodiment, additional blocks may be added or deleted, and the blocks may be executed in a different order than that described without departing from the spirit of the disclosure.

In block S11, the first user interface 12 issues a command resetting a configuration file of the communication interface 11. In block S12, the first user interface 12 issues a test command and begins to poll the communication interface 11. In block S13, the second user interface 13 retrieves the test command upon detection of successful reception of a test command by the communication interface 11.

In block S14, the second user interface 13 applies the test command to tested components indicated by the configuration file. In block S15, the second user interface 13 transmits the test results to the communication interface 11. In block S16, the first user interface 12 stops polling and retrieves the test results from the communication interface 11 and records the test results.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for communication between user interfaces of test programs, the system comprising:
a first user interface for issuing a test command;
a communication interface for receiving the test command from the first user interface;
a second user interface for polling the communication interface and stopping the polling upon detection of successful reception of the test command by the communication interface, and the second user interface retrieving the test command from the communication interface and executing the test command; and
a processor for executing the first user interface, the communication interface and the second user interface.

2. The system as claimed in claim 1, wherein the second user interface transmits test results to the communication interface after the test command is executed.

3. The system as claimed in claim 2, wherein the first user interface comprises a first polling agent, and the first polling agent begins polling the communication interface after issuing the test command and stops polling upon detection of successful reception of the test result by the communication interface.

4. The system as claimed in claim 2, wherein the first user interface retrieves the test results from the communication interface and records the test results.

5. The system as claimed in claim 2, wherein the communication interface maintains a configuration file recording corresponding transactions.

6. The system as claimed in claim 5, wherein the first user interface resets the communication file before issuing the test command.

7. A computer-implemented method for communication between user interfaces of test programs, the method comprising:
polling a communication interface until a test command issued from a first user interface being received by the communication interface;
retrieving the test command from the communication interface and executing the test command; and
transmitting test results to the communication interface after execution of the test command so that the first user interface is capable of retrieving the test results by polling the communication interface.

8. The method as claimed in claim 7, further comprising recording corresponding transactions in a configuration file.

9. The method as claimed in claim 8, further comprising resetting the communication file before polling the communication interface.
